(19) United States
(12) Patent Application Publication
(10) Pub. No.: US 2003/0103134 A1
(43) Pub. Date: Jun. 5, 2003

(54) Light source device and image recording apparatus

(75) Inventors: Hideki Hayashi, Kyoto (JP); Yasuyuki Koyagi, Kyoto (JP); Hiroyuki Kajiya, Kyoto (JP)

Correspondence Address: McDermott, Will & Emery, 600 13th Street, N.W., Washington, DC, 20005-3096, US

(73) Assignee: DAINIPPON SCREEN MFG.CO., LTD.

(21) Appl. No.: 10/303,733

(22) Filed: Nov. 26, 2002

(30) Foreign Application Priority Data
Nov. 30, 2001 (JP) P2001-365518

(51) Int. Cl. B41J 2/45

(52) U.S. Cl. 347/238

(57) ABSTRACT

In a light source device for image recording, a plurality of LED bare chips (211) and driving chips (213) on each of which current supply circuits are formed are directly mounted on one surface (214a) of a substrate (214). A plurality of LED bare chips (211) are two-dimensionally arranged in an area (211a) in high density, and this achieves downsizing of the light source device (21). One of the LED bare chips (211) is supplied with current from a plurality of current supply circuits formed on the driving chip (213). Therefore, if a trouble occurs in some of a plurality of current supply circuits, the LED bare chips (211) can be appropriately lighted up by changing the amount of current supply from other current supply circuits.

### BACKGROUND OF THE INVENTION

1. Field of the Invention

The present invention relates to a light source device for image recording and an image recording apparatus comprising the light source device.

2. Description of the Background Art

In an image recording apparatus which records an image by irradiating a photosensitive member with lights from a plurality of light emitting diodes, a large number of light emitting diodes are provided for speed-up of image recording. As the light emitting diodes, shell-type packages are used and these light emitting diodes are assembled on a multi-layer interconnection substrate. The light emitting diodes are supplied with current from current supply circuits and the lights emitted from the light emitting diodes are guided to the photosensitive member through an optical system. Then, by transferring an optical head comprising a light source and the optical system relatively to a stage holding the photosensitive member, a two-dimensional image is recorded on the photosensitive member.

When the shell-type package is used as the light emitting diode, since a part of light source corresponding to one channel can not be downsized, it is impossible to densely arrange a plurality of light emitting diodes. Therefore, when the number of light emitting diodes is increased, the light source device is upsized and a large optical system with high reduction ratio is needed to receive the lights from the light source device. As a result, the optical path length becomes longer, and this results in a loss of optical stability and an increase in manufacturing cost of the image recording apparatus.

On the other hand, while a calorific value becomes larger as the number of light emitting diodes increases, the light emitting diode of shell-type package has a structure in which current is supplied from a side opposite to a light emission side and therefore efficient cooling can not performed from the current supply side.

In the conventional image recording apparatus, each light emitting diode is supplied with current from one current supply circuit and if any one of the current supply circuits has a trouble, it becomes impossible to perform a normal image recording.

### SUMMARY OF THE INVENTION

A main object of the present invention is to downsize a light source device used in an image recording apparatus and another object is to ensure stable lighting of the light source device.

According to an aspect of the present invention, a light source device for image recording comprises a plurality of bare chips on each of which a semiconductor light emitting element is formed, and a substrate on which an electrode pattern is formed and the plurality of bare chips are mounted.

The present invention allows downsizing of the light source device.

Preferably, the semiconductor light emitting element is a light emitting diode.

Further preferably, the light source device further comprises a cooling mechanism for cooling a surface of the substrate on the opposite side to a surface on which the plurality of bare chips are mounted, and in the light source device, the surface of the substrate on the opposite side has no interconnection, and the cooling mechanism is entirely in contact with the surface on the opposite side to perform cooling.

According another aspect of the present invention, a light source device for image recording comprises a semiconductor light emitting element, and a plurality of current supply circuits for supplying the semiconductor light emitting element with current.

The light source device of the present invention allows a stable current supply to the semiconductor light emitting element.

Preferably, in the light source device, the amount of current supply is variable in at least one of a plurality of current supply circuits and the current supply circuits are formed on one semiconductor chip.

The present invention is also intended for an image recording apparatus for recording an image on a photosensitive member.

These and other objects, features, aspects and advantages of the present invention will become more apparent from the following detailed description of the present invention when taken in conjunction with the accompanying drawings.

### BRIEF DESCRIPTION OF THE DRAWINGS

FIG. 1 is a perspective view showing a constitution of an image recording apparatus;

FIG. 2 is a perspective view showing a constitution of a light source device;

FIG. 3 is a view showing an arrangement of bare chips;

FIG. 4 is a perspective view showing a state of mounting of the bare chip;

FIG. 5 is a cross section showing a constitution of the light source device; and

FIG. 6 is a view showing connection between current supply circuits and an LED bare chip.

### DESCRIPTION OF THE PREFERRED EMBODIMENTS

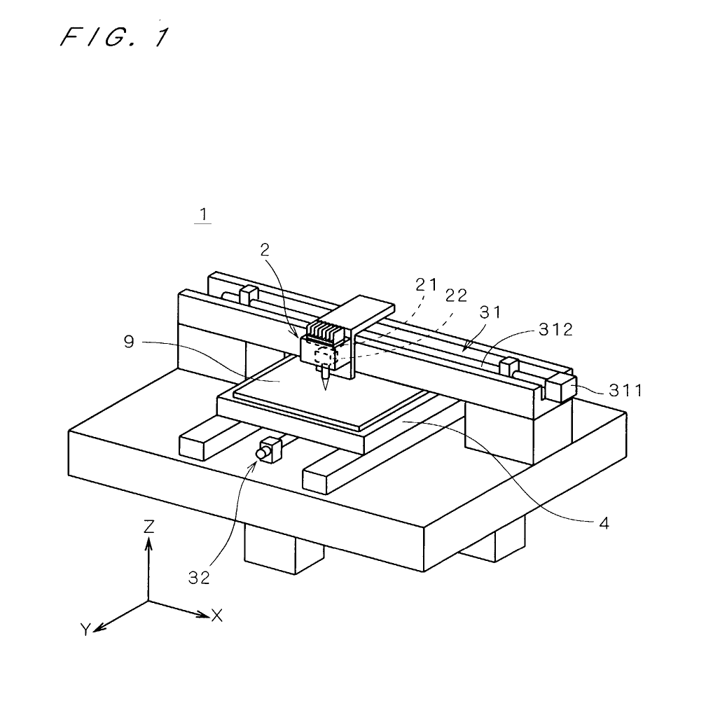

FIG. 1 is a perspective view showing a constitution of an image recording apparatus 1 of the first preferred embodiment of the present invention.

The image recording apparatus 1 comprises an optical head 2 for emitting lights for image recording, an X-direction transfer mechanism 31 for transferring the optical head 2 in an X direction of FIG. 1, a stage 4 for holding a photosensitive member 9 on which an image is recorded and a Y-direction transfer mechanism 32 for transferring the stage 4 in a Y direction of FIG. 1.

The optical head 2 comprises a light source device 21 and an optical system 22 for guiding lights emitted from the light source device 21 to the photosensitive member 9, and the photosensitive member 9 is exposed to the lights from the optical head 2, to thereby record an image. The X-direction transfer mechanism 31 comprises a motor 311 and a ball screw 312, and the motor 311 rotates to transfer the optical head 2 in the X direction of FIG. 1. The Y-direction transfer mechanism 32 also transfers the stage 4 in the Y direction of FIG. 1 with a motor and a ball screw, like the X-direction transfer mechanism 31.

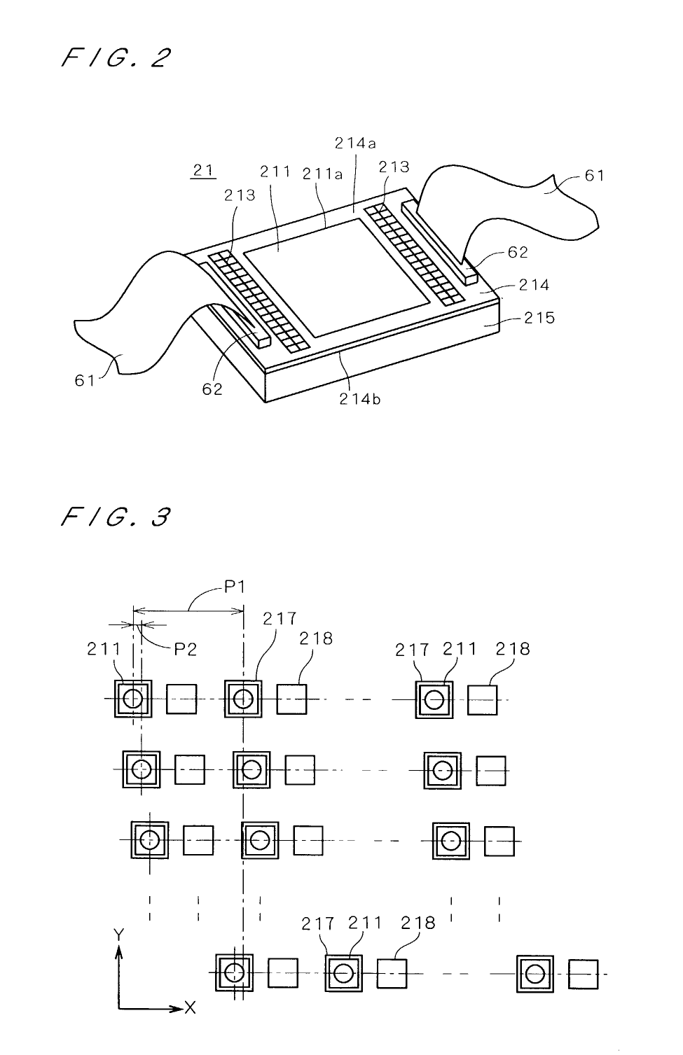

FIG. 2 is a perspective view showing a constitution of the light source device 21. In the light source device 21, a large number of bare chips 211 (hereinafter, referred to as “LED bare chip”) on each of which a light emitting diode is formed are mounted (assembled) on an area 211 a of a multi-layer printed circuit board (hereinafter, referred to as “substrate”) 214, and driving chips 213 each of which is a semiconductor chip on which a plurality of current supply circuits are formed are mounted around the area 211a. Each LED bare chip 211 is a unit of light source for recording an image, and the current supply circuits on the driving chip 213 supply the LED bare chip 211 with current. On the substrate 214, an electrode pattern connected to electrodes of the LED bare chips 211 and a wiring pattern electrically connecting the driving chips 213 and the LED bare chips 211.

The LED bare chips 211 and the driving chips 213 are mounted (assembled) on one surface 214a of the substrate 214, and a cooling device 215 (simply shown in FIG. 2) for removing a heat generated by the LED bare chips 211 is attached on the opposite surface 214b. The light source device 21 is further provided with cables 61 and connectors 62 which are used for supplying current from an external power supply to the driving chips 213. The present preferred embodiment uses the LED bare chip 211 on which a light emitting diode for emitting a light having a wavelength band of about 470 nm is formed.

FIG. 3 is a view showing an arrangement of the bare chips 211 mounted (assembled) on the substrate 214.

On the surface 214a of the substrate 214 on which the LED bare chips 211 are mounted, anode electrodes 217 on each of which the LED bare chip 211 is mounted are two-dimensionally arranged. In other words, a plurality of arrangement rows in each of which the anode electrodes 217 are aligned in the secondary scanning direction (X direction of FIG. 3) are formed in the primary scanning direction (Y direction of FIG. 3). A cathode electrode 218 is formed adjacently to each anode electrode 217.

For example, 64 LED bare chips 211 are mounted (assembled) in a row at a pitch of 1.28 mm (indicated by sign P1 in FIG. 3) in the secondary scanning direction, and 64 arrangement rows of the LED bare chips 211 are formed in the primary scanning direction while each row is offset in the secondary scanning direction by 0.2 mm (indicated by sign P2). The LED bare chip 211 is mounted on each anode electrode 217 with high accuracy, and therefore 4096 LED bare chips 211 are two-dimensionally arranged on the substrate 214.

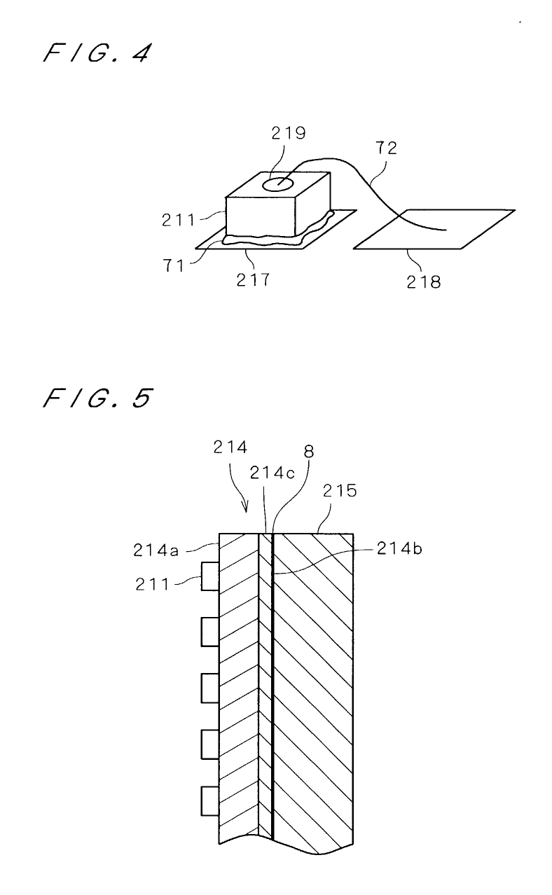

FIG. 4 is a perspective view showing a state of mounting of one LED bare chip 211. As discussed earlier, the LED bare chip 211 is mounted on the anode electrode 217 on the substrate 214 with conductive adhesive 71. The conductive adhesive 71 is obtained by mixing a silver filler (fine particles) into a mixture of epoxy resin and hardener. The anode electrode 217 and the LED bare chip 211 are electrically connected to each other through the silver filler by mounting and the epoxy resin and hardener are hardened by heating through crosslinking reaction.

Instead of the conductive adhesive 71 which is hardened by heating, a conductive adhesive which is hardened by light or an agent may be used. The cathode electrode 218 is formed adjacently to each anode electrode 217, and an electrode 219 on the LED bare chip 211 mounted on the anode electrode 217 and the adjacent cathode electrode 218 are connected to each other with a gold wire 72.

In the image recording by the image recording apparatus 1, lighting of each LED bare chip 211 is controlled on the basis of an image signal while the photosensitive member 9 is transferred relatively to the light source device 21 (the optical head 2) in the primary scanning direction. When one scanning in the primary scanning direction is completed, the light source device 21 slightly moves in the secondary scanning direction and the scanning in the primary scanning direction is performed again. Repeating the above operation, an image is finally recorded by dots aligned at equal pitch on each line on the photosensitive member 9. The arrangement of the LED bare chips 211 is not limited to the above, but any arrangement may be adopted depending on the use.

In the image recording apparatus 1, using the LED bare chips 211 allows a lot of LEDs to be two-dimensionally arranged in high density. Therefore, a lot of dots can be drawn at once and an image can be densely recorded at high speed. Further, it is possible to achieve downsizing, weight reduction and simplification of the light source device 21.

The optical system 22 in the optical head 2 can be downsized and the optical stability is increased. Downsizing of the optical system allows reduction in optical path length and ensures downsizing of the optical head 2 and reduction in manufacturing cost of the image recording apparatus 1.

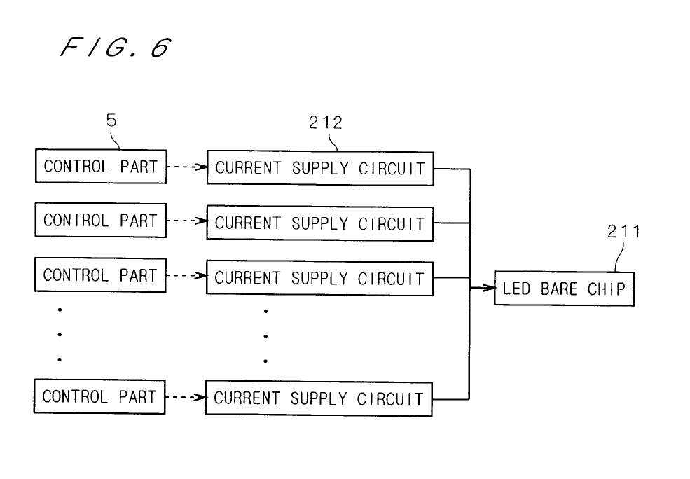

Next, a cooling mechanism in the light source device 21 will be discussed. FIG. 5 is a cross section showing a constitution of the light source device 21.

The substrate 214 on which the LED bare chips 211 are mounted (assembled) is formed of a material having high thermal conductivity such as aluminum nitride (AIN), and the surface 214b thereof opposite to the surface 214a on which the LED bare chips 211 are mounted is plane with no interconnection. In other words, a non-interconnection layer 214c without any electrode or the like is provided on a rear surface side of the substrate 214. The cooling device 215 is attached on (almost entirely in contact with) the surface 214b with a grease 8 having thermal conductivity substantially in surface-to-surface contact.

The heat generated by the LED bare chips 211 is transmitted in a thickness direction of the substrate 214 and the cooling device 215 directly cools the whole surface (almost the whole surface) of the non-interconnection layer 214c to efficiently remove the heat. This achieves the light source device 21 with excellent cooling capability.

When the LED bare chips 211 are densely arranged like in the light source device 21, in particular, since the calorific value per unit area of the substrate 214 becomes larger and therefore efficient cooling is needed. In the light source device 21, the cooling device 215 can be attached on the rear surface of the substrate 214.

The cooling device 215 may be radiating fins, a chiller unit or a fan unit, or may be a combination of one of these components and a Peltier device. Further, it is not necessarily needed that the cooling device 215 should be attached on the substrate 214 with the thermal-conductive grease 8. The non-interconnection layer 214c may be omitted, but it is preferable to provide the non-interconnection layer 214c for increasing the cooling efficiency.

FIG. 6 is a view showing a state where one LED bare chip 211 is supplied with current by a plurality of current supply circuits 212.

Each current supply circuit 212 receives a signal from an independent control part 5, to thereby control a value of current to be supplied to the LED bare chip 211. A plurality of current supply circuits 212 are connected to one LED bare chip 211. A chip on which a lot of current supply circuits 212 are formed is used as the driving chip 213 (see FIG. 2) and some (e.g., six or eight) of the current supply circuits 212 which are formed on one driving chip 213 are electrically connected to one LED bare chip 211.

As shown in FIG. 2, the driving chips 213 and the LED bare chips 211 are assembled on the same surface 214a of the substrate 214. The whole surface 214b of the substrate 214 can be cooled by the cooling device 215 and therefore the light source device 21 with excellent cooling capability can be achieved.

In FIG. 6, assuming that current required for lighting of the LED bare chip 211 is k [A] and one LED bare chip 211 is connected to n current supply circuits 212, each current supply circuit 212 supplies current of k/n [A].

If any one of the current supply circuits 212 is broken, by changing the setting of the control part 5, the value of current supplied by each of the remaining (n−1) current supply circuits 212 is changed to k/(n−1) [A]. This allows an appropriate lighting of the LED bare chip 211. In other words, in the light source device 21, if some of a plurality of current supply circuits 212 is broken, by changing the amount of current supply from the remaining current supply circuits 212, it is possible to stably light up the LED bare chip 211 like before the trouble occurs.

It is not necessarily needed that all the current supply circuits 212 can change the amount of current supply, and the stable lighting of the LED bare chip 211 can be achieved only if the amount of current supply is variable in at least one of the current supply circuits 212. For example, if one of n current supply circuits 212 is broken, by changing the setting of the control part 5 connected to another current supply circuit 212 whose amount of current supply is variable, it is possible to supply the current of k [A] to the LED bare chip 211.

Though the preferred embodiment of the present invention has been discussed, the present invention is not limited to the above preferred embodiment but allows various variations.

The optical head 2 and the stage 4 holding the photosensitive member 9 in the image recording apparatus 1 have only to relatively move in the X and Y directions of FIG. 1, and there may be a case, for example, where the stage 4 is fixed and the optical head 2 moves in the X and Y directions. Further, it is not needed that the photosensitive member 9 should be held on a plane, but may be held on a rotating drum.

Though the LED bare chips 211 which emit light having wavelength band of about 470 nm are used in the above preferred embodiment, light having other wavelength band may be used. The semiconductor light emitting element formed on the bare chip is not limited to the light emitting diode, but may be other types of light emitting elements such as a semiconductor laser. In the light source device 21, using the LED bare chip 211 which is easy to handle allows simplification of the structure of the light source device 21.

A chip mounted on the substrate 214, on which the light emitting element is formed, may not be exactly a bare chip, but has only to be one which is regarded as a bare chip. Usually, the bare chip (a chip which is regarded as the bare chip) on which the light emitting diode is formed has an area of 1 square mm or less and a general-type bare chip has an area of about 0.3 square mm. As the bare chip on which the semiconductor laser is formed, a bare chip having an area of 1.2 mm×0.3 mm may be used.

The semiconductor light emitting elements mounted (assembled) on one substrate 214 may emit lights of the same wavelength and may emit lights of different wavelength. For example, the semiconductor light emitting elements which emit lights of respective colors of RGB, i.e., red, green and blue, for a color photosensitive member may be used.

Though one light emitting diode is formed on one bare chip in the preferred embodiment, a plurality of semiconductor light emitting elements may be formed on one bare chip.

Though the bare chips on which the semiconductor light emitting elements are formed are two-dimensionally arranged on the substrate 214 in the preferred embodiment, it is not necessarily needed that the bare chips should be two-dimensionally arranged, but the bare chips may be one-dimensionally arranged. From the viewpoint of speedup, naturally, it is preferable that the bare chips should be two-dimensionally arranged.

Though the conductive adhesive 71 is used for mounting the bare chips on the substrate 214 in the above preferred embodiment, a soldering paste or the like may be used. Since the conductive adhesive 71, however, is easier to handle than the soldering paste and the curing temperature of the conductive adhesive 71 is lower than that of the soldering paste, using the conductive adhesive 71 reduces damages to the bare chips in mounting. Further, the conductive adhesive 71, which uses resin as a binder, can produce an effect of preventing a crack of the bare chips, or the like, and therefore it is preferable that the conductive adhesive 71 should be used for mounting the bare chips.

It is not necessarily needed that the cooling device 215 should be in contact with the substrate 214 in the light source device 21, and the substrate 214 may be cooled, e.g., by blowing an airflow from a fan to the rear surface 214b of the substrate 214.

Though the surface 214b of the substrate 214 opposite to the surface on which the bare chips are mounted is a plane in the preferred embodiment, since the number of layers of the substrate 214 increases if a large number of bare chips are mounted, it is not necessarily needed that the surface 214b should be a plane. For example, the surface 214b may have a shape in which a portion where a lot of internal wires are formed swells. More specifically, there may be a case where the surface 214b has a shape with swollen ridgeline at its center (like a roof) by combining two slopes and a lot of internal wires are formed near the ridgeline. Even if the surface 214b is not a plane, cooling the whole surface 214b allows efficient cooling of the light source device 21.

There may be a case where only ON/OFF of the current supply circuit 212 is controlled. For example, (n+m) current supply circuits 212 having the fixed amount k/n [A] of current supply are connected to one semiconductor light emitting element which needs current of k [A] for lighting and only n of the (n+m) current supply circuits 212 are controlled to turn on. In this case, m current supply circuits 212 are spares and if any one of the current supply circuits 212 in use is broken, by turning on one of the m current supply circuits 212 not in use, the current of k [A] can be supplied to the semiconductor light emitting element. In other words, the amount of current supply to the semiconductor light emitting element may be controlled by the number of the current supply circuits 212 in use among (n+m) current supply circuits 212 having the fixed amount of current supply.

While the invention has been shown and described in detail, the foregoing description is in all aspects illustrative and not restrictive. It is therefore understood that numerous modifications and variations can be devised without departing from the scope of the invention.

What is claimed is:

1. A light source device for image recording, comprising:
a plurality of bare chips on each of which a semiconductor light emitting element is formed; and
a substrate on which an electrode pattern is formed and said plurality of bare chips are mounted.

2. The light source device according to claim 1, wherein
said plurality of bare chips are two-dimensionally arranged on said substrate.

3. The light source device according to claim 1, wherein
said semiconductor light emitting element is an light emitting diode.

4. The light source device according to claim 1, wherein
said plurality of bare chips are mounted on said substrate with conductive adhesive.

5. The light source device according to claim 1, further comprising
a cooling mechanism for cooling a surface of said substrate on the opposite side to a surface on which said plurality of bare chips are mounted.

6. The light source device according to claim 5, wherein
said surface of said substrate on said opposite side has no interconnection, and said cooling mechanism is entirely in contact with said surface on said opposite side, to perform cooling.

7. A light source device for image recording, comprising:
a semiconductor light emitting element; and
a plurality of current supply circuits for supplying said semiconductor light emitting element with current.

8. The light source device according to claim 7, wherein
the amount of current supply is variable in at least one of said plurality of current supply circuits.

9. The light source device according to claim 7, wherein
said plurality of current supply circuits are formed on one semiconductor chip.

10. The light source device according to claim 9, wherein
said semiconductor light emitting element is formed on each of said plurality of bare chips, said plurality of bare chips are mounted on one surface of a substrate, and said semiconductor chip is mounted on said one surface.

11. An image recording apparatus for recording an image on a photosensitive member, comprising:
an optical head which comprises a light source device and an optical system; and
a transfer mechanism for transferring a photosensitive member relatively to said optical head, wherein
said light source device comprises:
a plurality of bare chips on each of which a semiconductor light emitting element is formed; and
a substrate on which an electrode pattern is formed and said plurality of bare chips are mounted.

12. The image recording apparatus according to claim 11, wherein
said plurality of bare chips are two-dimensionally arranged on said substrate.

13. The image recording apparatus according to claim 11, wherein
said semiconductor light emitting element is an light emitting diode.

14. The image recording apparatus according to claim 11, wherein
said plurality of bare chips are mounted on said substrate with conductive adhesive.

15. The image recording apparatus according to claim 11, wherein
said light source device further comprises a cooling mechanism for cooling a surface of said substrate on the opposite side to a surface on which said plurality of bare chips are mounted.

16. The image recording apparatus according to claim 15, wherein
said surface of said substrate on said opposite side has no interconnection, and said cooling mechanism is entirely in contact with said surface on said opposite side, to perform cooling.

17. An image recording apparatus for recording an image on a photosensitive member, comprising:
an optical head which comprises a light source device and an optical system; and
a transfer mechanism for transferring a photosensitive member relatively to said optical head, wherein
said light source device comprises:
a semiconductor light emitting element; and
a plurality of current supply circuits for supplying said semiconductor light emitting element with current.

18. The image recording apparatus according to claim 17, wherein
the amount of current supply is variable in at least one of said plurality of current supply circuits.

19. The image recording apparatus according to claim 17, wherein
said plurality of current supply circuits are formed on one semiconductor chip.

20. The image recording apparatus according to claim 19, wherein
said semiconductor light emitting element is formed on each of said plurality of bare chips, said plurality of bare chips are mounted on one surface of a substrate, and said semiconductor chip is mounted on said one surface.
